(19) United States
(12) Patent Application Publication
(10) Pub. No.: US 2025/0222360 A1
(43) Pub. Date: Jul. 10, 2025

(54) METHODS, SYSTEMS, AND APPARATUSES FOR GENERATING POOL COMPETITIONS

(71) Applicant: Underdog Sports, LLC, Brooklyn, NY (US)

(72) Inventors: Guy Lake, Brooklyn, NY (US); Weston Jossey, Brooklyn, NY (US); Brandon Stakenborg, Brooklyn, NY (US); Cliff Braton, Brooklyn, NY (US)

(21) Appl. No.: 19/012,531

(22) Filed: Jan. 7, 2025

Related U.S. Application Data
(60) Provisional application No. 63/618,618, filed on Jan. 8, 2024.

(51) Int. Cl. A63F 13/828; A63F 13/335

(52) U.S. Cl. CPC A63F 13/828; A63F 13/335

(57) ABSTRACT

Methods, apparatuses, and systems are described for generating pool competitions. A user may provide an entry that includes an entry fee and a pick count and predictions for the number of pick counts associated with a pool competition. The user may be placed into the pool competition where users are given an amount of points based on each user's entry fee and level of difficulty associated with each user's pick count predictions. After the pool competition settles, points associated with the correct predictions may be tallied. The user may receive a portion of the amount of points based on the amount of correct predictions made by the user. The user may be provided an award amount based on the amount of points earned by the user.

### CROSS REFERENCE TO RELATED PATENT APPLICATION

This Application claims priority to U.S. Non-Provisional Application No. 63/618,618, filed Jan. 8, 2024, which is herein incorporated by reference in its entirety.

### BACKGROUND

Fantasy sports contests, such as pickem competitions, have become increasingly popular in recent years. These competitions typically involve users predicting outcomes of one or more games over a predefined period of time and accumulating points for correct predictions. However, existing pickem competitions face several technical challenges that limit their accessibility and adaptability. One significant technical problem is the inability of conventional pickem systems to provide universal accessibility across different locations. Current systems are often restricted to specific geographical areas due to varying regulations and legal requirements. This results in users being unable to access the competitions depending on their location, creating a fragmented user experience. Another technical challenge is the lack of adaptability to changing regulations in different jurisdictions. As laws and regulations governing fantasy sports and online gaming evolve, existing pickem systems struggle to dynamically adjust their functionality to remain compliant across multiple locations. This can lead to competitions becoming inaccessible in certain areas over time, even if they were previously available. Additionally, conventional pickem systems typically employ a player-versus-house model, which limits the types of competition structures that can be offered. This restricts the ability to create more engaging and diverse contest formats that could appeal to a wider range of users. Furthermore, existing systems often face difficulties in accurately assessing and distributing rewards based on the relative difficulty of users' predictions. This can lead to imbalanced or unfair competition outcomes, potentially diminishing user engagement and satisfaction.

### SUMMARY

It is to be understood that both the following general description and the following detailed description are exemplary and explanatory only and are not restrictive.

Methods, systems, and apparatuses for generating pool competitions are described. A user may provide an entry, associated with a plurality of events, that includes a user input of an entry fee and a user input of a pick count of a number of events for which to provide predictions. The user may then provide a prediction for each event of the associated number of pick counts indicated for a pool competition. The user may be placed into the pool competition where users are given an amount of points based on each user's entry fee and level of difficulty associated with each user's pick count predictions. After the pool competition settles, points associated with the correct predictions may be tallied. The user may receive a portion of the amount of points based on the amount of correct predictions made by the user. The user may be provided an award amount based on, or in proportion to, the amount of points earned by the user. In addition, the award amount may be increased based on whether there is a high win rate for the pool competition.

In an embodiment, are methods comprising determining, by a computing device, a plurality of events for a gaming session, receiving, from each user device of a plurality of users devices, an associated with a price and an amount of events of the plurality of events, wherein each user device is associated with a user, receiving, from each user device, a prediction associated with each event of the plurality of events associated with the corresponding amount of events, determining, for each user of each user device, a measure of difficulty associated with the corresponding predictions associated with each corresponding user, determining, based on the corresponding price received from each user device and the corresponding measure of difficulty associated with the corresponding predictions associated with each corresponding user, a quantity of points for each user for the gaming session, determining, for each user, a portion of the quantity of points associated with an amount of correct predictions of the corresponding predictions associated with each corresponding user, and sending, to each user, an indication of a respective award associated with the portion of the quantity of points associated with each corresponding user.

In an embodiment, are methods comprising determining, by a computing device, based on a plurality of price entries from a plurality of users and a plurality of prediction inputs from the plurality of users, a quantity of points associated with a gaming session, determining, for each user, a portion of the quantity of points associated with an amount of correct predictions associated with each corresponding user, determining, for each user, based on the amount of correct predictions associated with the plurality of users satisfying a win-rate threshold, an increase in a respective award associated with the portion of the quantity of points associated with each corresponding user, and sending, to each user, an indication of the respective award associated with each corresponding user.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIGS. 2A-2B show a flowchart of an example method;

FIGS. 3A-3B show a flowchart of an example method;

FIG. 4 shows an example graph of payout multipliers associated with gaming sessions;

FIG. 5 shows a flowchart of an example method; and

FIG. 6 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Fantasy sports contests, such as pickem competitions, have steadily increased in recent years. Conventional pickem competitions typically involve competitions in which users predict outcomes of one or more games over a predefined period of time, accumulating points for correct predictions. These existing competitions involve a player versus house competitions. However, since these existing pickem competitions do not include any type of tournament-style competition, they are not accessible from every location, thus preventing users from accessing the competitions depending on the location of the user. Moreover, these existing pickem competitions are not adaptable to changing regulations for different locations. Thus, although these existing pickem competitions may be accessible at a location at one point in time, these existing pickem competitions may subsequently become inaccessible at the location at a later point in time due to changing regulations of that location.

By way of example, the present methods, systems, and apparatuses address these challenges by generating pool competitions wherein users of a pool competition may receive an award according to a portion of an amount of points for the pool competition based on an amount of correct predictions made by the users. For example, a user may utilize an application that may be implemented via a user device in order to provide an entry, associated with a plurality of events, that includes a user input of an entry fee and a user input of a pick count of a number of events for which to provide predictions. The user may then provide a prediction for each event of the associated number of pick counts indicated for a pool competition. The user may be placed into the pool competition where users are given an amount of points based on each user's entry fee and level of difficulty associated with each user's pick count predictions. After the pool competition settles, points associated with the correct predictions may be tallied. The user may receive a portion of the amount of points based on the amount of correct predictions made by the user. The user may be provided an award amount based on, or in proportion to, the amount of points earned by the user. In addition, the award amount may be increased based on whether there is a high win rate for the pool competition.

This approach allows for the seamless generation of pool competitions that may be accessible from all locations. Moreover, by adapting the pool competition based on each user's entry, the pool competition may remain accessible from all locations, regardless of changing regulations associated with each location.

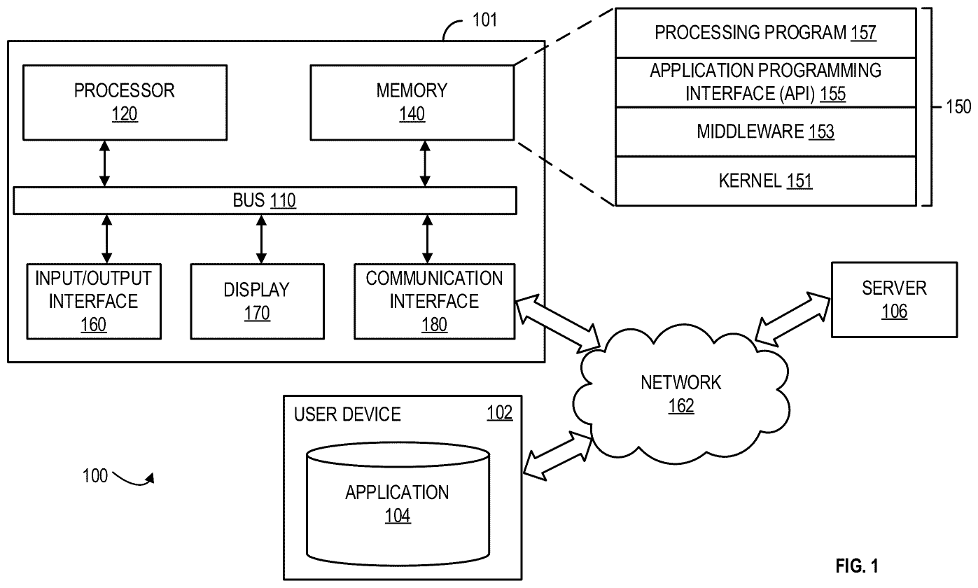

FIG. 1 shows an example system 100 for generating pool competitions (e.g., gaming sessions). A plurality of events for a pool competition may be determined. Each event of the plurality of events may comprise a predicted outcome associated with a player statistic associated with a sports event. A user may provide an entry comprising a user input of an entry fee (e.g., price) and a user input of a pick count (e.g., amount of events) for a pool competition. Based on the pick count, the user may select a prediction for each event associated with an amount of events according to the pick count. In addition, a measure of difficulty may be associated with each user's entry based on the amount of events and the predictions of each event. A quantity of points per user may be determined based on each user's entry fee and measure of difficulty associated with each user's entry. After each event associated with the pool competition concludes (e.g., the pool competition settles), a total number of correct predictions per user of the pool competition may be determined. Each corresponding user with correct predictions may receive a portion of the quantity of points for each corresponding user. An indication of a respective award associated with each corresponding user with at least one correct prediction may be sent to each corresponding user. The system 100 may include a backend platform device 101, one or more user devices 102, and one or more external servers 106. In an example, the backend platform device 101 may be configured to receive user inputs and generate one or more gaming sessions (e.g., pool competitions) based on the user inputs. In an example, the backend platform device 101 may be in communication with the user devices 102, and the one or more external servers 106 via a network (e.g., network 162).

The backend platform device 101 may include a bus 110, one or more processors 120, a memory 140, an input/output interface 160, a display 170, and a communication interface 180. In certain examples, the backend platform device 101 may omit at least one of the aforementioned elements or may additionally include other elements. The backend platform device 101 may comprise, for example, a host server capable of processing the user inputs in order to generate the gaming sessions.

The bus 110 may comprise a circuit for connecting the bus 110, the one or more processors 120, the memory 140, the input/output interface 160, the display 170, and/or the communication interface 180 to each other and for delivering communication (e.g., a control message and/or data) between the bus 110, the one or more processors 120, the memory 140, the input/output interface 160, the display 170, and/or the communication interface 180.

The one or more processors 120 may include one or more of a Central Processing Unit (CPU), an Application Processor (AP), or a Communication Processor (CP). The one or more processors 120 may control, for example, at least one of the bus 110, the memory 140, the input/output interface 160, the display 170, and/or the communication interface 180 of the backend platform device 101 and/or may execute an arithmetic operation or data processing for communication. As an example, the one or more processors 120 may cause the backend platform device 101 to process the user input via a processing program 157 in order to generate the gaming sessions. The processing (or controlling) operation of the one or more processors 120 according to various embodiments is described in detail with reference to the following drawings.

The processor-executable instructions executed by the one or more processors 120 may be stored and/or maintained by the memory 140. The memory 140 may include a volatile and/or non-volatile memory. The memory 140 may include random-access memory (RAM), flash memory, solid state or inertial disks, or any combination thereof. As an example, the memory 140 may include an Embedded MultiMedia Card (eMMC). The memory 140 may store, for example, a command or data related to at least one of the bus 110, the one or more processors 120, the memory 140, the input/output interface 160, the display 170, and/or the communication interface 180 of the backend platform device 101. According to various examples, the memory 140 may store software and/or a program 150 or may comprise firmware. For example, the program 150 may include a kernel 151, a middleware 153, an Application Programming Interface (API) 155, a processing program 157, and/or the like, configured for controlling one or more functions of the backend platform device 101 and/or an external device (e.g., the one or more servers 106). At least one part of the kernel 151, middleware 153, or API 155 may be referred to as an Operating System (OS). The memory 140 may include a computer-readable recording medium (e.g., a non-transitory computer-readable medium) having a program recorded therein to perform the methods according to various embodiments by the one or more processors 120. In an example, the memory 140 may store the customized content.

The kernel 151 may control or manage, for example, system resources (e.g., the bus 110, the one or more processors 120, the memory 140, etc.) used to execute an operation or function implemented in other programs (e.g., the middleware 153, the API 155, or the input processing program 157). Further, the kernel 151 may provide an interface capable of controlling or managing the system resources by accessing individual elements of the data capture device 101 in the middleware 153, the API 155, or the input processing program 157.

The middleware 153 may perform, for example, a mediation role, so that the API 155, and/or the input processing program 157 can communicate with the kernel 151 to exchange data. Further, the middleware 153 may handle one or more task requests received from the input processing program 157 according to a priority. For example, the middleware 153 may assign a priority of using the system resources (e.g., the bus 110, the one or more processors 120, or the memory 140) of the backend platform device 101 to at least one of the input processing program 157. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, and/or character control, as an interface capable of controlling a function provided by the input processing program 157 in the kernel 151 or the middleware 153.

The input processing program 157 may include logic (e.g., hardware, software, firmware, etc.) that may be implemented (e.g., executed by the one or more processors 120) to process the user inputs received from one or more users, such as via one or more user devices 102. The user devices 102 may comprise a laptop computer, a mobile phone, a smart phone, a tablet computer, a wearable device, a smartwatch, a desktop computer, a smart television, and the like. Each user device may be associated with a user. The user devices 102 may be configured to include an application 104 for providing the user input. In an example, the application 104 may comprise a mobile application or a web browser. Each user device 102 may execute the application 104, wherein the application 104 may cause the user devices 102 to output a user interface that may be configured to receive one or more entries associated with one or more gaming sessions (e.g., pool competitions). The input processing program 157 may be implemented to cause the backend platform device 101 to determine a plurality of events for the gaming session. In an example, the gaming session may comprise a predetermined amount of users. Each event of the plurality of events may comprise a predicted outcome associated with a player statistic associated with a sports event (e.g., game such as a basketball game, a baseball game, a football game, a hockey game, etc.). Each entry may comprise an interface for receiving a user input of a price (e.g., entry fee, pick price, etc.) and a user input of an amount of events (e.g., pick counts) associated with the plurality of events. For example, each user of each user device 102 may provide an entry comprising a user input of a price and a user input of an amount of events. For example, a user may be provided an input field to enter a price (e.g., $5, $20, $50, $100, etc.) and an input field to enter a number of pick counts (e.g., Pick 2, Pick 3, Pick 4, Pick 5, Pick 6, Pick 7, Pick 8, etc.). As an example, the number of pick counts are example numbers and any number of pick counts may be provided. Each user may provide a prediction associated with each event of the plurality of events up to the user input amount of events (e.g., 5 predictions for Pick 5, 4 predictions for Pick 4, etc.). For example, each user may select events from the plurality of events up to the user input amount of events. Each user may select an initial predicted outcome of each event or provide an alternative prediction (e.g., higher or lower than the initial predicted outcome) for each event. For example, a user that selected Pick 2 may provide a first prediction associated with a first player associated with a first sports event and provide a second prediction associated with a second player associated with a second sports event. The backend platform device 101 may determine a measure of difficulty associated with each user's predictions. For example, a first user may have provided a prediction that a player in a basketball game will score 20 points in a single game, while a second user may have provided a prediction that a quarterback in a football game will score 20 touchdowns in a single game. The second user's prediction may be assigned a higher measure of difficulty due to a low probability of a quarterback scoring 20 touchdowns in a single game, while the first user's prediction may be assigned a lower measure of difficulty due to a higher probability of a basketball player scoring 20 points in a single game. The backend platform device 101 may determine a quantity of points for each user for the gaming session based on the corresponding price received from each user device and the corresponding measure of difficulty associated with the corresponding predictions associated with each corresponding user. In an example, the quantity of points provided to each user may be further based on one or more parameters. The one or more parameters may comprise one or more of an insurance designation or a scorcher designation. For example, the quantity of points provided to a user may increase/decrease based on the one or more parameters. For example, a Pick Count may be given additional points if a pick or a plurality of picks in the Pick Count are associated with a scorcher designation, while a Pick Count may be given less points if it is associated with an insurance designation.

Each event of the plurality of events may be associated with a time duration for settling. For example, since each event comprises player statistics during a sports event, the final statistics for the player would not finalize until the end of the sports event. Thus, the final statistics for each event associated with a user's entry would not finalize/settle until after the end of the longest duration of the events associated with the user's entry. Once the events (e.g., statistics) finalize (e.g., each sports event ends), the user may be placed in a pool (e.g., gaming session) with other users that have entries where each of the corresponding user's events have settled (e.g., settled within a designated time duration or time frame). The backend platform device 101 may determine an amount of correct predictions by each user for the gaming session. Each user may receive a portion of the quantity of points based on, or associated with, the corresponding amount of correct predictions by each corresponding user. In an example, the backend platform device 101 may determine a total amount of points associated with the amount of correct predictions from every user. The backend platform device 101 may send an indication of a respective award associated with the portion of the quantity of points associated with each corresponding user to each corresponding user with correct predictions (e.g., at least one correct prediction). In an example, the indication may comprise one or more of a text message, a push notification, or an email message. In an example, the indication may comprise the award. The award for the corresponding user may be proportional to the portion of the quantity of points for the corresponding user. For example, the award for a user may be determined based on dividing a total amount of winning points for the gaming session with an amount of winning points for a user.

In an example, the backend platform device 101 may perform a “smoothing” process in the event the gaming session produces a high win rate. For example, the backend platform device 101 may determine a total quantity of points associated with a gaming session based on a plurality of price entries from a plurality of users and a plurality of prediction inputs from the plurality of users (e.g., via user devices 102). The backend platform device 101 may determine, for each user, a portion of the quantity of points associated with an amount of correct predictions associated with each corresponding user. The backend platform device 101 may determine, for each pool, a limit to the number of entrants or entry fees, to increase the respective award associated with the portion of the quantity of points associated with each corresponding user based on the amount of correct predictions associated with the plurality of users satisfying a win-rate threshold. As an example, the backend platform device 101 may determine, for each user, an increase in a respective award associated with the portion of the quantity of points associated with each corresponding user based on the amount of correct predictions associated with the plurality of users satisfying the win-rate threshold. For example, the backend platform device 101 may determine a total sum of the prices (e.g., entry fees) provided by the plurality of users, wherein a total award amount for the gaming session may comprise a first portion (e.g., 20%, 40%, 60%, 80%, etc.) of the total sum of the prices (e.g., entry fees) provided by the plurality of users. The backend platform device 101 may determine an additional award amount for the gaming session based on a second portion of the total sum of the prices (e.g., entry fees) provided by the plurality of users. The additional award amount may be added to the total award amount of the gaming session based on a high win rate (e.g., a high number of correct predictions from the plurality of users) associated with the gaming session. The total award amount for the gaming session may increase based on the additional award amount. Thus, the award amount per point for the gaming session may be increased based on the additional award amount. In an example, the total award amount for the gaming session may also be increased by limiting the number of users in a given gaming session. As such, the award amount per point for the gaming session may increase based on fewer winning competitors diluting the pool. Each user with correct predictions will receive an increased award based on the increased award amount per point based on the additional award amount added to the total award amount for the gaming session.

The applications 104 of the user devices 102 may be configured to provide one or more user interfaces for receiving user entries/inputs associated with the gaming sessions and to display results of the gaming sessions. For example, the application 104 may output a first user interface configured to display a screen/window for receiving one or more user entries associated with one or more gaming sessions. For example, the first user interface may be configured to receive a user input of a price (e.g., entry fee, pick price, etc.) and a user input of an amount of events (e.g., pick counts). In an example, the first user interface may be output (e.g., displayed) based on a location of the user device 102. A user may provide the user inputs via the first user interface of a price and an amount of events of the one or more amounts of events. Based on the user inputs, the application 104 may output a second user interface configured to display an option for receiving inputs of the predictions for each event of the plurality of events up to the amount of events. For example, the user may select events from the plurality of events up to the user input amount of events. Based on the user input predictions, the application 104 may output a third user interface configured to display results associated with each prediction associated for a gaming session. The results (e.g., display of the results) may be updated based on correct predictions associated with the gaming session. In addition, the application 104 may output an indication associated with an award amount based on a user having one or more correct predictions.

The input/output interface 160 may include an interface for delivering an instruction or data input from a user (e.g., an operator of the backend platform device 101) or from a different external device (e.g., user device 102 or servers 106) to the different elements of the backend platform device 101. The input/output interface 160 may further include an interface for outputting one or more user interfaces to the user. For example, the input/output interface 160 may comprise a display, such as a touch screen display, and/or one or more physical input interfaces (e.g., keyboard, mouse, etc.) configured to receive user inputs. Further, the input/output interface 160 may output an instruction or data received from one or more elements of the backend platform device 101 to one or more external devices (e.g., user device 102 or servers 106).

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. The input processing program 157 may cause the display 170 to output an interface displaying the user entries (e.g., pick prices and/or pick counts) associated with one or more gaming sessions (e.g., pool competitions) and results associate with each gaming session.

The communication interface 180 may establish, for example, communication between the data capture device 101 and one or more external devices (e.g., the display device 102, the electronic device 104, and/or the server 106). For example, the communication interface 180 may communicate with the one or more external devices (e.g., the user device 102 and/or the servers 106) by being connected to a network 162 through wireless communication or wired communication. The network 162 may include, for example, at least one of a telecommunications network, a computer network (e.g., LAN or WAN), the Internet, and/or a telephone network.

The communication interface 180 may be configured to communicate with the one or more external devices (e.g., user device 102 or server 106) via the network 162 (e.g., Internet, LAN, etc.). In an example, the communication interface 180 may be configured to access the network 162 via a wireless communication interface such as a cellular communication protocol. The cellular communication protocol may comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface may be configured to use a near-distance communication. The near-distance communication interface may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document.

The external servers 106 may include a group of one or more external servers. For example, all or some of the operations executed by the backend platform device 101 may be executed in a different server or a plurality of external servers 106. In an example, if the backend platform device 101 needs to perform a certain function or service either automatically or based on a request, the backend platform device 101 may request at least some parts of functions related thereto alternatively or additionally to a different server 106 or plurality of external servers 106 instead of executing the function or the service autonomously. One or more of the external servers 106 may execute the requested function or additional function, and may deliver a result thereof to the backend platform device 101. The backend platform device 101 may provide the requested function or service either directly or by additionally processing the received result. For example, a cloud computing, distributed computing, or client-server computing technique may be used.

In an example, the backend platform device 101 and/or the external servers 106 may include one or more databases. For example, the databases may be used to store a plurality of user profiles associated with a plurality of users of the user devices 102. For example, the users may login (e.g., via the application 104) before starting a gaming session. The user profiles may comprise information associated with the users that may be used to determine one or more preferences associated with the users such as most frequent pick price(s), most frequent pick count(s), favorite player(s), favorite team(s), favorite sport(s), and the like. In addition, the user profiles may be used to output important/relevant statistics associated with one or more of a user's favorite player(s), team(s), and/or sport(s). In an example, the database may store a plurality of statistical data and reference sources. A statistic may have an associated reference source indicating an origin of the at least one statistic, for example.

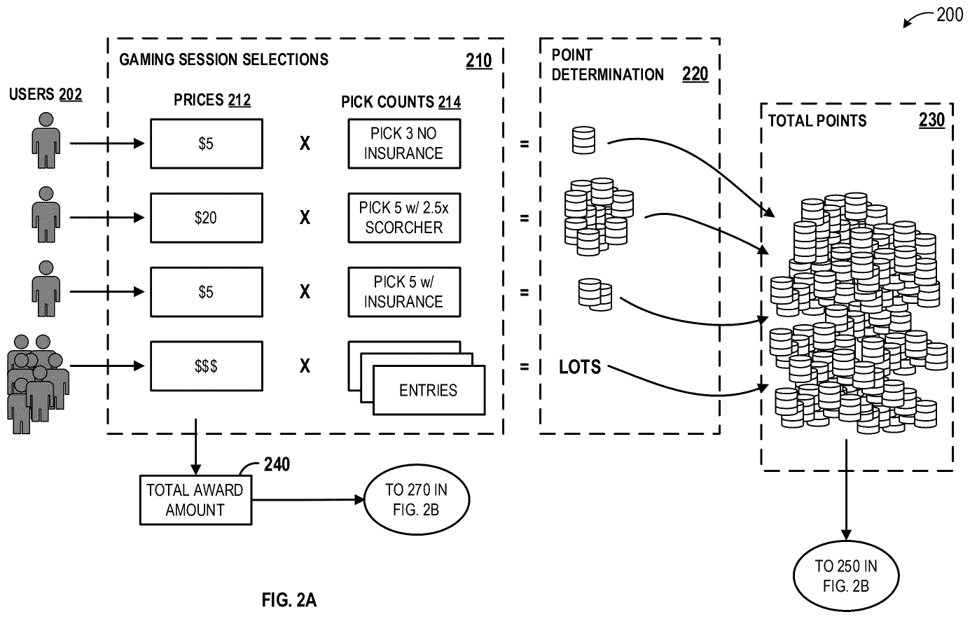

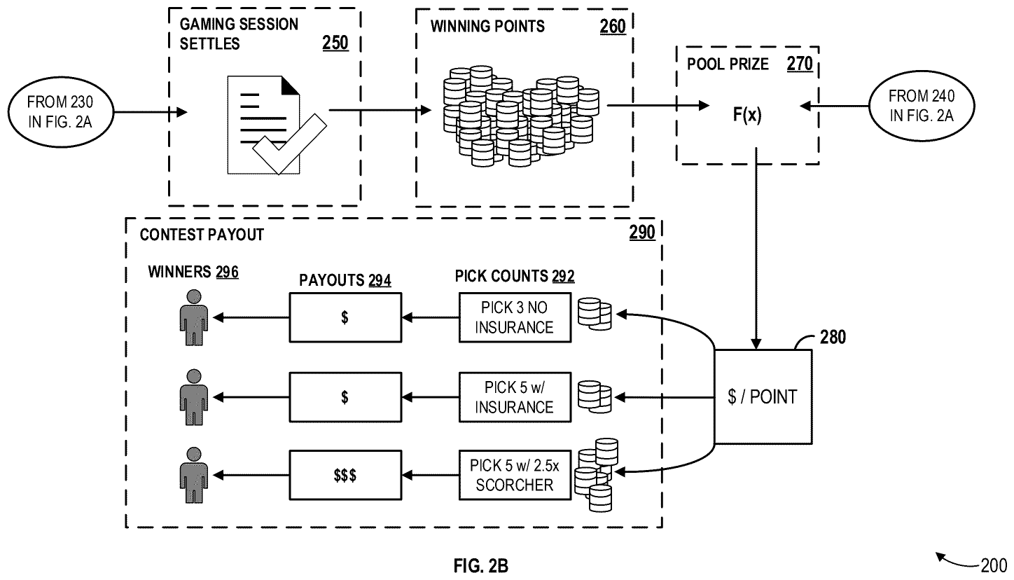

FIGS. 2A-2B show a flowchart of an example method 200 for generating a gaming session (e.g., pool competition). Users 202 (e.g., via user devices 102, such as via application 104) may provide user inputs for the gaming session at 210. The users 202 may provide an entry comprising a price 212 (e.g., entry fee) and a pick count 214 (e.g., amount of events). For example, a first user may provide a user input of a $5 entry fee and a user input of a Pick 3 pick count without insurance, a second user may provide a user input of a $20 entry fee and a user input of a Pick 5 pick count with a 2.5× scorcher, a third user may provide a user input of a $5 entry fee and a user input of a Pick 5 pick count, and a group of users may provide user inputs associated with a designated entry fee and a designated pick count. After the users 202 provide the prices 212 and the pick counts 214, the users 202 may provide user inputs of predictions associated with the pick counts. For example, the pick counts 214 may be associated with a plurality of events. For example, each user may select events from the plurality of events up to the user input amount of events. Each event of the plurality of events may comprise a predicted outcome associated with a player statistic associated with a sports event. Each user 202 may select the initial predicted outcome of each event or provide an alternative prediction (e.g., higher or lower than the initial predicted outcome) for each event.

At 220, each user, or group of users, may receive a quantity of points based on the corresponding price received from each user device and the corresponding measure of difficulty associated with the corresponding predictions associated with each corresponding user. In an example, the quantity of points may be determined further based on one or more parameters. The one or more parameters may comprise one or more of an insurance designation or a scorcher designation. For example, the first user may receive a standard amount of points based on a standard measure of difficulty associated with the first user's predictions and the first user's picks without insurance. The second user may receive a larger amount of points based on the higher measure of difficulty associated with the second user's predictions and/or the second user's picks being associated with a 2.5× scorcher designation. The third user may receive a smaller amount of points based on the lower measure of difficulty associated with the third user's predictions and/or the third user's picks being associated with an insurance designation. The group of users may receive a collection (e.g., lot) of points for the group based on the group's predictions and the group's picks.

At 230, a total amount of points may be determined based on the quantity of points received by each user 202. For example, the total amount of points may be the sum total of the points received by the users 202 of the gaming session. At 240, a total award amount may be determined based on the total sum of the prices (e.g., entry fees) provided by the users 202. For example, the total award amount may comprise a portion of the total sum of the prices.

At 250, the gaming session may settle. Each event of the plurality of events may be associated with a time duration for settling. For example, since each event comprises player statistics during a sports event, the final statistics for the player would not finalize until the end of the sports event. Thus, the final statistics for each event associated with a user would not finalize/settle until after the end of the longest duration of the events associated with the user. Once the events (e.g., statistics) finalize (e.g., each sports event ends), the user may then be placed in a pool (e.g., gaming session) with other users that have entries where each of the corresponding user's events have settled (e.g., settled within a designated time duration or time frame).

At 260, a total amount of winning points may be determined. For example, a portion of the total amount of points may be determined based on an amount of correct predictions. In an example, the total amount of winning points may be associated with an expected win rate. At 270, the total award amount may be compared with the total quantity of winning points. At 280, the award amount per point may be determined. For example, the total award amount may be divided by the total quantity of winning points to determine the award amount per point.

At 290, the users 202 with correct predictions (e.g., winners 296 with at least one correct prediction) may receive an award amount based on an amount of correct predictions. For example, each winner 296 may receive a quantity of points associated with a number of correct predictions by the winner 296. In an example, the quantity of points may be further determined based on the one or more parameters and/or the pick counts 292. Each winner 296 may receive a payout 294 associated with the quantity of points earned by each winner 296. For example, the payout 294 may be determined based on dividing the total amount of winning points for the gaming session with the amount of winning points associated with a user (e.g., winner 296). As an example, the first user may receive a payout associated with a quantity of points associated with an amount of correct predictions associated with the entry of the Pick 3 pick count with no insurance. The third user may receive a payout associated with a quantity of points associated with an amount of correct predictions associated with the entry of the Pick 5 pick count with insurance. The second user may receive the largest payout based on a quantity of points associated with an amount of correct predictions associated with the entry of the Pick 5 pick count with a 2.5× scorcher designation.

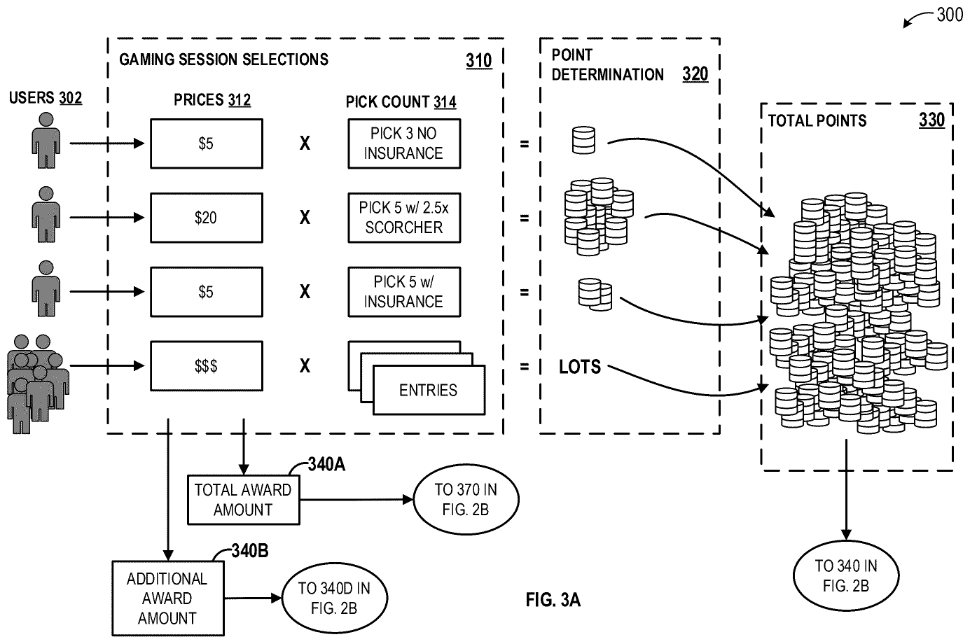

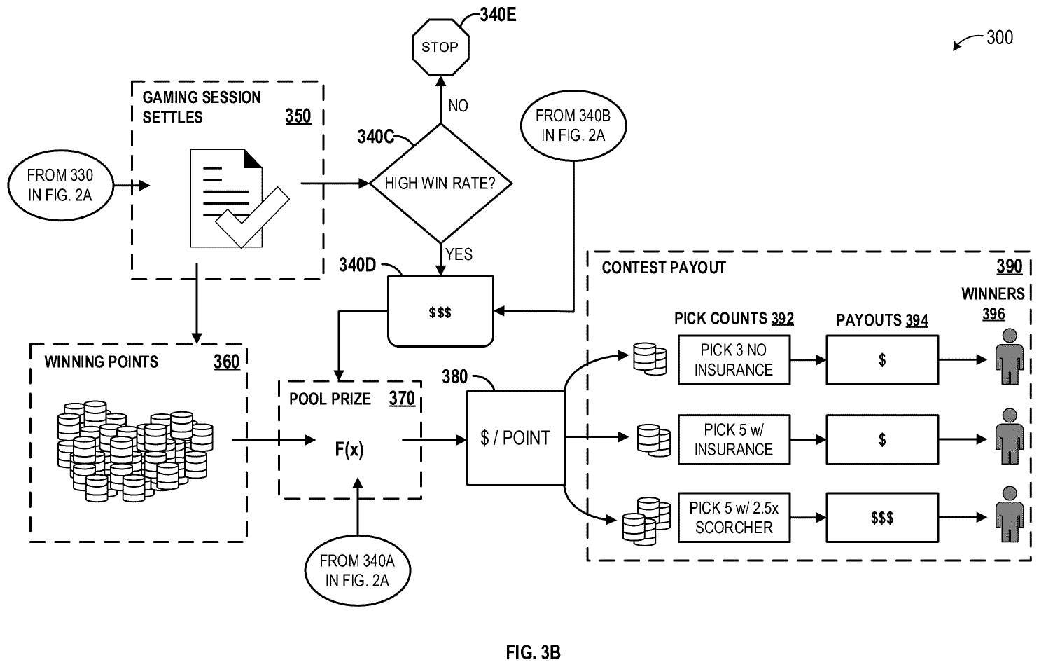

FIGS. 3A-3B show a flowchart of an example method 300 for generating a gaming session (e.g., pool competition) wherein a “smoothing” process is performed on the gaming session in the event the gaming session produces a high win rate. The steps associated with 210, 220, 230, and 240 shown in FIG. 2A are similar to the steps associated with 310, 320, 330, and 340A shown in FIG. 3A, respectively. For example, users 302 may provide an entry comprising a price 312 (e.g., entry fee) and a pick count 314 (e.g., amount of events), wherein a total amount of points may be determined based on the price entries 312 and the pick counts 314 received from the users 302.

At 340B, an additional award amount may be determined. For example, a total award amount for the gaming session may comprise a first portion of the total sum of the prices 312 (e.g., entry fees) provided by the users 302. The additional award amount may be determined based on a second portion of the total sum of the prices 312 (e.g., entry fees) provided by the users 302.

At 350, the gaming session may settle. Each event of the plurality of events may be associated with a time duration for settling. For example, since each event comprises player statistics during a sports event, the final statistics for the player would not finalize until the end of the sports event. Thus, the final statistics for each event associated with a user would not finalize/settle until after the end of the longest duration of the events associated with the user. Once the events (e.g., statistics) finalize (e.g., each sports event ends), the user may then be placed in a pool (e.g., gaming session) with other users that have entries where each of the corresponding user's events have settled (e.g., settled within a designated time duration or time frame).

At 340C, it may be determined whether there is a high win rate (e.g., high number of correct predictions from the users 302) associated with the gaming session. For example, a high win rate may cause the points to exceed a target multiplier (e.g., such as when a Pick 5 pick count drops below a 20× multiplier). If there is a high win rate, the additional award amount may be added, at 340D, to the total award amount. If there is not a high win rate, the additional award amount is not added, at 340E, to the total award amount.

At 360, a total quantity of winning points may be determined. For example, a portion of the total quantity of points may be determined based on an amount of correct predictions. In an example, the total quantity of winning points may be associated with an expected win rate. At 370, the total award amount may be compared with the total quantity of winning points. In an example, if there is a high win rate, the total award amount may comprise the total award amount determined at 340A in addition to the additional award amount determined at 340B. In an example, if there is not a high win rate, the total award amount may simply comprise the total award amount determined at 340A.

At 380, the award amount per point may be determined. For example, the total award amount may be divided by the total quantity of winning points to determine the award amount per point. As an example, the award amount per point may be increased based on the additional award amount based on a determination that there is a high win rate.

At 390, the users 302 with correct predictions (e.g., winners 396 with at least one correct prediction) may receive an award amount based on an amount of correct predictions. For example, each winner 396 may receive a quantity of points associated with a number of correct predictions by the winner 396. In an example, the quantity of points may be further determined based on the one or more parameters and/or the pick counts 392. Each winner 396 may receive a payout 394 associated with the quantity of points earned by each winner 396. For example, the payout 394 may be determined based on dividing the total quantity of winning points for the gaming session with the quantity of winning points associated with a user (e.g., winner 396). As an example, the first user may receive a payout associated with a quantity of points associated with an amount of correct predictions associated with the entry of the Pick 3 pick count with no insurance. The third user may receive a payout associated with a quantity of points associated with an amount of correct predictions associated with the entry of the Pick 5 pick count with insurance. The second user may receive the largest payout based on a quantity of points associated with an amount of correct predictions associated with the entry of the Pick 5 pick count with a 2.5× scorcher designation.

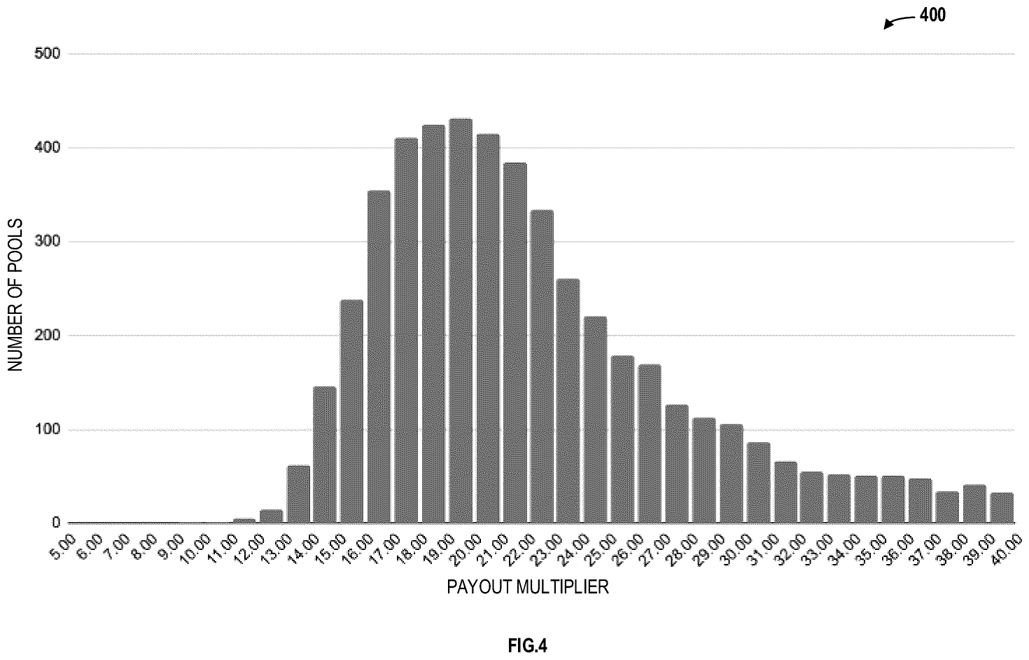

FIG. 4 shows an example graph 400 of payout multipliers associated with a plurality of gaming sessions (e.g., pools) associated with a Pick 5 pick count. A shown in FIG. 4, a majority of the gaming sessions experienced a payout multiplier between 15× and 26×. As an example, the “smoothing” process may reduce the probability of very low payouts (e.g., awards) for users. For example, the probability that a user receives a 10× payout on what would have previously provided (e.g., paid) 20× may be reduced. As an example, if a user wins 5 entries (e.g., 5 correct predictions) and is entered into 5 different gaming sessions, the user has a higher probability of averaging an expected payout across all of the user's gaming sessions combined. Without the “smoothing” process, the user has an increased chance of experiencing the win rate for that particular gaming session. For example, for a gaming session where a high number of popular picks win all at once, in a “non-smoothed” gaming session, there is a high probability of lower payouts. In a “smoothed” gaming session, there is a higher probability of a payout with the same random distribution as another gaming session the user entered, wherein the associated competition performs average. For gaming sessions where a user's competition performs poorly, users of the gaming session may have a high probability of receiving a greater share of the total award amount.

TABLE I

| | | | | | | | | Sum of |
|---|---|---|---|---|---|---|---|---|
| | | | Multiplier | | Multiplier | | Points | Winning |
| Entry | Pick | | (all | | (all | Multiplier | (all | Entry |
| Fee | Count | Insurance | correct) | Scorcher | correct) | (1 wrong) | correct) | Points |
| $1 | 3 | No | 6 | 0 | N/A | 0 | 6 | 21,800 |
| $1 | 3 | Yes | 3 | 0 | N/A | 1 | 3 | 21,800 |
| $5 | 3 | No | 6 | 0 | N/A | 0 | 30 | 21,800 |
| $5 | 3 | Yes | 3 | 0 | N/A | 1 | 15 | 21,800 |
| $5 | 3 | No | 6 | 2.5 | 15 | 0 | 75 | 21,800 |
| $5 | 3 | Yes | 3 | 2.5 | 7.5 | 2.5 | 37.5 | 21,800 |
| $20 | 5 | No | 20 | 0 | N/A | 0 | 400 | 21,800 |
| $20 | 5 | Yes | 10 | 0 | N/A | 2.5 | 200 | 21,800 |
| $20 | 5 | No | 20 | 2.5 | 50 | 0 | 1,000 | 21,800 |
| $20 | 5 | Yes | 10 | 2.5 | 25 | 6.25 | 500 | 21,800 |

Table I shows example entry fees and pick counts and resulting points based on the entry fees and pick counts based on whether each entry (e.g., each entry fee and pick count entry) is associated with an insurance designation and/or a scorcher designation. For example, multipliers may be associated with each entry based on whether each entry is associated with an insurance designation and/or a scorcher designation. The amount of points received for each entry may be determined based on the multipliers associated with each entry.

The disclosed methods and systems provide a technical solution to several technical problems in the field of online gaming and fantasy sports competitions. Specifically, the methods and systems address challenges related to universal accessibility, regulatory compliance, and fair reward distribution in pool-based gaming competitions. At least one technical problem solved by the disclosed methods and systems is the lack of universal accessibility in conventional pickem systems. These systems are often restricted to specific geographical areas due to varying regulations, resulting in a fragmented user experience. The disclosed methods and systems solve this by implementing a pool-based competition structure that may be adaptable to different regulatory environments, potentially allowing users from various locations to participate in the same gaming sessions. Another technical problem addressed is the difficulty in adapting to changing regulations across different jurisdictions. The disclosed flexible structure may allow for dynamic adjustment of competition parameters, such as entry fees, pick counts, and payout structures, to remain compliant with evolving legal requirements in different areas. The disclosed methods and systems also provide a technical solution to the challenge of fairly assessing and distributing rewards based on the relative difficulty of users' predictions. By incorporating a measure of difficulty for each prediction and adjusting point allocations accordingly, the disclosed methods and systems may create a more balanced and engaging competition environment. This is an improvement over conventional systems that may not account for varying levels of prediction difficulty. Furthermore, the disclosed methods and systems introduce a technical solution to the problem of maintaining user engagement and satisfaction in scenarios with high win rates. The “smoothing” process described reduces the probability of very low payouts, providing a more consistent and rewarding experience for users across multiple gaming sessions. By implementing advanced algorithms for point allocation, difficulty assessment, and payout calculations, the disclosed methods and systems represent an advancement in the technical capabilities of gaming competition systems. The use of dynamic pool creation based on settled events and the ability to adjust award amounts based on win rates demonstrates technical improvements in the management and execution of online gaming competitions.

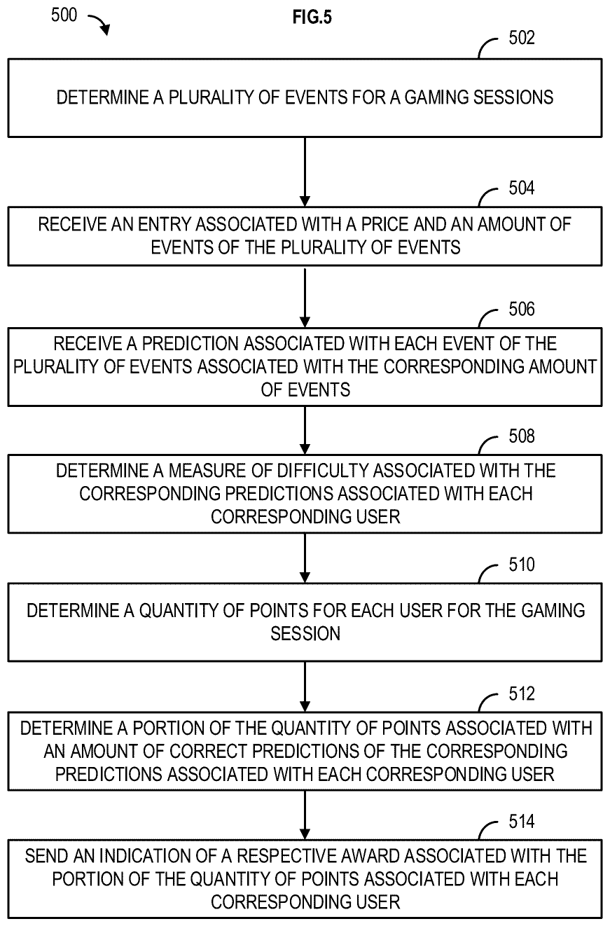

FIG. 5 shows a flowchart of an example method 500 for generating a gaming session (e.g., pool competition) based on a plurality of users. Method 500 may be implemented by a computing device (e.g., backend platform device 101, servers 106, etc.). At step 502, a plurality of events for a gaming session may be determined. For example, the computing device (e.g., backend platform device 101, servers 106, etc.) may determine the plurality of events for the gaming session. Each event of the plurality of events may comprise a predicted outcome associated with a player statistic associated with a sports event. In an example, each event may be associated with a time duration for settling. For example, since each event comprises player statistics during a sports event/game, the final statistics would not finalize/settle until the end of the sports event/game. The gaming session may comprise a predetermined amount of users. For example, the gaming session may stop allowing users to join once the gaming session reaches the predetermined amount of users. Subsequent users may be added to a new gaming session.

At step 504, an entry associated with a price and an amount of events of the plurality of events may be received from each user device of a plurality of user devices. For example, the computing device (e.g., backend platform device 101, servers 106, etc.) may receive the entry associated with the price and the amount of events from each user device of the plurality of user devices. As an example, a user may provide an entry associated with a price (e.g., entry fees, pick prices), such as $5, $20, $50, etc., and an amount of events (e.g., pick counts), such as Pick 2, Pick 4, Pick 5, Pick 6, Pick 7, Pick 8, etc. The amount of events may comprise at least two events. Each user device may be associated with a user.

At step 506, a prediction associated with each event of the plurality of events associated with the corresponding amount of events may be received from each user device. For example, the computing device (e.g., backend platform device 101, servers 106, etc.) may receive the prediction associated with each event of the plurality of events associated with the corresponding amount of events from each user device. For example, a user may select events from the plurality of events up to the user input amount of events. For example, a user may provide five predictions based on a selection of 5 events (e.g., pick 5). For example, the user may provide a first prediction for a first player associated with a first sports event, a second prediction for a second player associated with a second sports event, a third prediction for a third player associated with a third sports event, a fourth prediction for a fourth player associated with a fourth sports event, and a fifth prediction for a fifth player associated with a fifth sports event.

At step 508, a measure of difficulty associated with the corresponding predictions associated with each corresponding user may be determined for each user of each user device. For example, the computing device (e.g., backend platform device 101, servers 106, etc.) may determine the measure of difficulty associated with the corresponding predictions associated with each corresponding user for each user of each user device. For example, a first user may have provided a prediction that a player in a basketball game will score 20 points in a single game, while a second user may have provided a prediction that a quarterback in a football game will score 20 touchdowns in a single game. The second user's prediction may be assigned a higher measure of difficulty due to a lower probability of a quarterback scoring 20 touchdowns in a single game, while the first user's prediction may be assigned a lower measure of difficulty due to the higher probability of a basketball player scoring 20 points in a single game.

At step 510, a quantity of points for each user for the gaming session may be determined based on the corresponding price received from each user device and the corresponding measure of difficulty associated with the corresponding predictions associated with each corresponding user. For example, the computing device (e.g., backend platform device 101, servers 106, etc.) may determine the quantity of points for each user for the gaming session based on the corresponding price received from each user device and the corresponding measure of difficulty associated with the corresponding predictions associated with each corresponding user. In an example, the quantity of points provided to each user may be further based on one or more parameters. The one or more parameters may comprise one or more of an insurance designation or a scorcher designation.

At step 512, a portion of the quantity of points associated with an amount of correct predictions of the corresponding predictions associated with each corresponding user may be determined for each user. For example, the computing device (e.g., backend platform device 101, servers 106, etc.) may determine, for each user, the portion of the quantity of points associated with an amount of correct predictions of the corresponding predictions associated with each corresponding user. Each event of the plurality of events may be associated with a time duration for settling. For example, since each event comprises player statistics during a sports event, the final statistics for the player would not finalize until the end of the sports event. Thus, the final statistics for each event associated with a user would not finalize/settle until after the end of the longest duration of the events associated with the user. Once the events (e.g., statistics) finalize (e.g., each sports event ends), the user may then be placed in a pool (e.g., gaming session) with other users that have entries where each of the corresponding user's events have settled (e.g., settled within a designated time duration or time frame). An amount of correct predictions by each user for the gaming session may be determined. Each user may receive a portion of the quantity of points based on, or associated with, the corresponding amount of correct predictions by each corresponding user. In an example, a total amount of points associated with the amount of correct predictions from every user may be determined.

At step 514, an indication of a respective award associated with the portion of the quantity of points associated with each corresponding user may be sent to each user. For example, the computing device (e.g., backend platform device 101, servers 106, etc.) may send the indication to each user. The respective award may comprise an award amount that is proportional to the portion of the quantity of points for the corresponding user. For example, the respective award may be determined based on dividing a total amount of winning points for the gaming session with an amount of winning points associated with a user. In an example, the indication may comprise one or more of a text message, a push notification, or an email message. In an example, the indication may comprise the award.

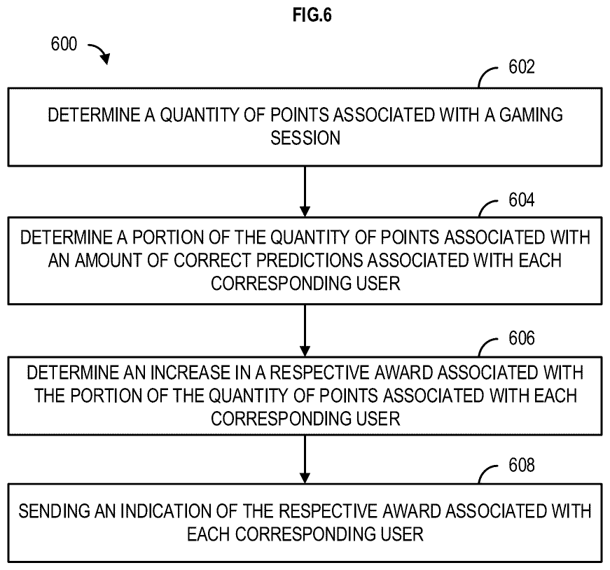

FIG. 6 shows a flowchart of an example method 600 for generating a gaming session (e.g., pool competition) for a user. Method 600 may be implemented by a computing device (e.g., backend platform device 101, servers 106, etc.). At step 602, a quantity of points associated with a gaming session may be determined based a plurality of price entries from a plurality of users and a plurality of prediction inputs from the plurality of users. For example, a computing device (e.g., backend platform device 101, servers 106, etc.) may determine the quantity of points associated with the gaming session based the plurality of price entries from the plurality of users and the plurality of prediction inputs from the plurality of users. The gaming session may comprise a predetermined amount of users. For example, the gaming session may stop allowing users to join once the gaming session reaches the predetermined amount of users. Subsequent users may be added to a new gaming session.

In an example, the quantity of points may be determined based on the plurality of price entries from the plurality of users and a measure of difficulty associated with each prediction input from each user of the plurality of users. For example, the plurality of prediction inputs may be associated with a plurality of events. Each event of the plurality of events may comprise a predicted outcome associated with a player statistic associated with a sports game. Each user of the plurality of uses may provide a prediction associated with each event of the plurality of events up to the amount of events entry (e.g., 5 predictions for Pick 5, 4 predictions for Pick 4, etc.). For example, a user may provide five predictions based on an entry of 5 events (e.g., pick 5). For example, the user may provide a first prediction for a first player associated with a first sports event, a second prediction for a second player associated with a second sports event, a third prediction for a third player associated with a third sports event, a fourth prediction for a fourth player associated with a fourth sports event, and a fifth prediction for a fifth player associated with a fifth sports event. A measure of difficulty associated with each user's predictions may be determined. For example, a first user may have provided a prediction that a player in a basketball game will score 20 points in a single game, while a second user may have provided a prediction that a quarterback in a football game will score 20 touchdowns in a single game. The second user's prediction may be assigned a higher measure of difficulty due to a lower probability of a quarterback scoring 20 touchdowns in a single game, while the first user's prediction may be assigned a lower measure of difficulty due to the higher probability of a basketball player scoring 20 points in a single game. In an example, each prediction input of the plurality of prediction inputs may be associated with at least two events. In an example, the quantity of points associated with the gaming session may be further determined based on one or more parameters associated with each amount of events entry from each user of the plurality of users. The one or more parameters may comprise one or one of an insurance designation or a scorcher designation.

At step 604, a portion of the quantity of points associated with an amount of correct predictions associated with each corresponding user may be determined for each user. For example, the computing device (e.g., backend platform device 101, servers 106, etc.) may determine, for each user, the portion of the quantity of points associated with the amount of correct predictions associated with each corresponding user. Each event of the plurality of events may be associated with a time duration for settling. For example, since each event comprises player statistics during a sports event, the final statistics for the player would not finalize until the end of the sports event. Thus, the final statistics for each event associated with a user would not finalize/settle until after the end of the longest duration of the events associated with the user. Once the events (e.g., statistics) finalize (e.g., each sports event ends), the user may then be placed in a pool (e.g., gaming session) with other users that have entries where each of the corresponding user's events have settled (e.g., settled within a designated time duration or time frame). An amount of correct predictions by each user for the gaming session may be determined. Each user may receive a portion of the quantity of points based on, or associated with, the corresponding amount of correct predictions by each corresponding user. In an example, a total amount of points associated with the amount of correct predictions from every user may be determined.

At step 606, an increase in a respective award associated with the portion of the quantity of points associated with each corresponding user may be determined for each user based on the amount of correct predictions associated with the plurality of users satisfying a win-rate threshold. For example, the computing device (e.g., backend platform device 101, servers 106, etc.) may determine, for each user, the increase in a respective award associated with the portion of the quantity of points associated with each corresponding user based on the amount of correct predictions associated with the plurality of users satisfying the win-rate threshold. For example, a total sum of the prices (e.g., entry fees) provided by the plurality of users may be determined, wherein a total award amount for the gaming session may comprise a first portion of the total sum of the prices (e.g., entry fees) provided by the plurality of users. An additional award amount for the gaming session may be determined based on a second portion of the total sum of the prices (e.g., entry fees) provided by the plurality of users. In an example, the gaming session may be associated with a high number of correct predictions associated with the plurality of users (e.g., high win rate). Based on the high win rate (e.g., satisfying the win-rate threshold, or the win rate is above the win rate threshold), the additional award amount may be added to the total award amount for the gaming session to increase an award amount per winning point for the gaming session. For example, the respective award for each user may comprise an award amount that is proportional to the portion of the quantity of points for the corresponding user. For example, the respective award may be determined based on dividing a total amount of winning points for the gaming session with an amount of winning points associated with a user.

At step 608, an indication of the respective award associated with the portion of the quantity of points associated with each corresponding user may be sent to each user. For example, the computing device (e.g., backend platform device 101, servers 106, etc.) may send the indication to each user. In an example, the indication may comprise one or more of a text message, a push notification, or an email message. In an example, the indication may comprise the award.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
determining, by a computing device, a plurality of events for a gaming session;
receiving, from each user device of a plurality of users devices, an entry associated with a price and an amount of events of the plurality of events, wherein each user device is associated with a user;
receiving, from each user device, a prediction associated with each event of the plurality of events associated with the corresponding amount of events;
determining, for each user of each user device, a measure of difficulty associated with the corresponding predictions associated with each corresponding user;
determining, based on the corresponding price received from each user device and the corresponding measure of difficulty associated with the corresponding predictions associated with each corresponding user, a quantity of points for each user for the gaming session;
determining, for each user, a portion of the quantity of points associated with an amount of correct predictions of the corresponding predictions associated with each corresponding user; and
sending, to each user, an indication of a respective award associated with the portion of the quantity of points associated with each corresponding user.

2. The method of claim 1, wherein each event of the plurality of events comprises a predicted outcome associated with a player statistic associated with a sports event.

3. The method of claim 1, wherein the amount of events comprises at least two events.

4. The method of claim 1, wherein determining the quantity of points comprises determining the quantity of points based on one or more parameters associated with an amount of events.

5. The method of claim 4, wherein the one or more parameters comprises one or one of an insurance designation or a scorcher designation.

6. The method of claim 1, wherein the gaming session comprises a predetermined amount of users.

7. The method of claim 1, wherein the respective award is determined based on dividing a total amount of winning points with an amount of winning points associated with a user.

8. The method of claim 1, wherein the respective award is proportional to the portion of the quantity of points for the corresponding user.

9. The method of claim 1, wherein the indication comprises one or more of a text message, a push notification, or an email message.

10. The method of claim 1, wherein the indication comprises the award.

11. A method comprising:
determining, by a computing device, based on a plurality of price entries from a plurality of users and a plurality of prediction inputs from the plurality of users, a quantity of points associated with a gaming session;
determining, for each user, a portion of the quantity of points associated with an amount of correct predictions associated with each corresponding user;
determining, for each user, based on the amount of correct predictions associated with the plurality of users satisfying a win-rate threshold, an increase in a respective award associated with the portion of the quantity of points associated with each corresponding user; and
sending, to each user, an indication of the respective award associated with each corresponding user.

12. The method of claim 11, wherein determining, based on the plurality of price entries from the plurality of users and the plurality of prediction inputs from the plurality of users, the quantity of points associated with the gaming session comprises:
determining, based on the plurality of price entries from the plurality of users and a measure of difficulty associated with each prediction input from each user of the plurality of users, the quantity of points associated with the gaming session.

13. The method of claim 11, wherein determining the quantity of points associated with the gaming session comprises determining the quantity of points associated with the gaming session based on one or more parameters associated with each amount of events entry from each user of the plurality of users.

14. The method of claim 13, wherein the one or more parameters comprises one or one of an insurance designation or a scorcher designation.

15. The method of claim 11, wherein the plurality of prediction inputs are associated with a plurality of events.

16. The method of claim 15, wherein each event of the plurality of events comprises a predicted outcome associated with a player statistic associated with a sports game.

17. The method of claim 11, wherein the each prediction input of the plurality of prediction inputs is associated with at least two events.

18. The method of claim 11, wherein the gaming session comprises a predetermined amount of users.

19. The method of claim 11, wherein the indication comprises one or more of a text message, a push notification, or an email message.

20. The method of claim 11, wherein the indication comprises the award.
